(19) United States
(12) Patent Application Publication
(10) Pub. No.: US 2021/0106979 A1
(43) Pub. Date: Apr. 15, 2021

(54) CATALYST FOR REMOVING NITROGEN OXIDE AND MANUFACTURING METHOD THEREOF

(71) Applicants: HYUNDAI MOTOR COMPANY, Seoul (KR); KIA MOTORS CORPORATION, Seoul (KR); KOREA RESEARCH INSTITUTE OF CHEMICAL TECHNOLOGY, Daejeon (KR)

(72) Inventors: Dalyoung YOON, Seongnam-si (KR); Chang Hwan KIM, Seongnam-si (KR); Tae Sun CHANG, Daejeon (KR); Iljeong HEO, Daejeon (KR); Sung Hun LEE, Daejeon (KR); Young Woo YOU, Daejeon (KR)

(21) Appl. No.: 16/828,063

(22) Filed: Mar. 24, 2020

(30) Foreign Application Priority Data
Oct. 11, 2019 (KR) 10-2019-0125772

(51) Int. Cl. B01J 23/46; B01J 21/06; B01J 23/10; B01J 37/02; B01J 37/08; B01D 53/94

(52) U.S. Cl. CPC B01J 23/468; B01J 21/063; B01J 23/10; B01J 21/066; B01J 37/0228; B01J 37/0244; B01D 2255/2063; B01J 37/088; B01D 53/9413; B01D 2255/1026; B01D 2255/20707; B01D 2255/20715; B01D 2255/1028; B01J 37/0217

(57) ABSTRACT

A manufacturing method thereof, and the catalyst for removing the nitrogen oxide includes a powdery gamma alumina support on which at least one selected from a group of titanium (Ti), lanthanum (La), or zirconium (Zr) is supported, wherein the support may be further supported with iridium (Ir) and ruthenium (Ru).

### CROSS-REFERENCE TO RELATED APPLICATION

This application claims priority to and the benefit of Korean Patent Application No. 10-2019-0125772 filed in the Korean Intellectual Property Office on Oct. 11, 2019, the entire contents of which are incorporated herein by reference.

### BACKGROUND OF THE DISCLOSURE

### (a) Field of the Disclosure

The present embodiments relate to a catalyst for removing a nitrogen oxide having high heat resistance and high performance, and a manufacturing method thereof.

### (b) Description of the Related Art

Generally, exhaust gases of a vehicle include carbon monoxide (CO), hydrocarbon (HC), a particulate matter (PM), a nitrogen oxide (NOₓ), and the like, which are harmful materials. Particularly, the nitrogen oxide causes environmental problems such as photochemical smog and acid rain, and disease problems of a human body. In order to remove such a nitrogen oxide, exhaust gas post-treatment technologies such as a selective catalyst reduction (SCR) catalyst, a lean NOₓ trap (LNT catalyst), and the like have been developed. However, application of the exhaust gas post-treatment techniques to a gasoline vehicle causes a significant cost increase and is accompanied by inconvenience of maintenance and repair of the vehicle such as filling of urea fluid. In addition, in a high load region of an engine, due to a lack of ammonia (NH₃) generated by urea fluid decomposition, nitrogen oxide (NOₓ) purification performance may be reduced. Therefore, recently, as a technology to solve the problem while performing exhaust gas post-treatment of a gasoline engine in accordance with environmental regulations of a vehicle, a three-way catalyst (TWC) that functions to simultaneously remove carbon monoxide, a nitrogen oxide, and hydrocarbons based on a noble metal catalyst such as palladium (Pd), has been developed and has been applied to exhaust gas post-treatment of the gasoline engine. As such, when the exhaust gas post-treatment is performed by using the three-way catalyst, a control method in which lean fuel and rich fuel conditions of the engine are alternately altered to oxidize carbon monoxide and hydrocarbons and reduce a nitrogen oxide is required. However, in the rich fuel condition, harmful components of the exhaust gas including the nitrogen oxide are removed at close to 100%, but there is a problem that purification performance of the nitrogen oxide is drastically reduced in a region in which an air/fuel ratio (λ) exceeds 1.00. Particularly, in a region in which the catalyst deteriorates due to exposure to high temperature exhaust gas and the air/fuel ratio (λ) exceeds 1.05, the nitrogen oxide purification performance is only about 10%. Therefore, it is urgently required to develop an exhaust gas post-treatment method that may provide excellent nitrogen oxide purification performance in various environments. The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present embodiments provide a catalyst for removing a nitrogen oxide that has excellent nitrogen oxide purification performance even in a region in which an air/fuel ratio (λ) exceeds 1.00.

In addition, the present embodiments provide a catalyst for removing nitrogen oxides that may significantly improve nitrogen oxide purification performance even after the catalyst is degraded due to exposure to high temperature exhaust gas.

An embodiment of the present disclosure provides a catalyst for removing nitrogen oxides including a powdery gamma alumina support on which at least one selected from a group consisting of titanium (Ti), lanthanum (La), and zirconium (Zr) is supported, wherein the support may be further supported with iridium (Ir) and ruthenium (Ru).

Another embodiment of the present disclosure provides a method of manufacturing a catalyst for removing a nitrogen oxide, including: preparing a first support by supporting at least one selected from a group consisting of titanium (Ti), lanthanum (La), and zirconium (Zr) on a powdery gamma alumina support; preparing a second support by supporting iridium (Ir) and ruthenium (Ru) on the first support; calcining the second support at a high temperature in an air atmosphere; and slurry-coating the prepared catalyst on a honeycomb structure.

According to exemplary embodiments of the present disclosure, even in a region in which an air/fuel ratio (λ) exceeds 1.00, nitrogen oxide purification performance is excellent, and even though a catalyst is degraded due to exposure to high temperature exhaust gas, the nitrogen oxide purification performance may be significantly improved.

### BRIEF DESCRIPTION OF THE DRAWING

FIG. 1 is a graph showing a conversion rate of a nitrogen oxide for a catalyst manufactured according to Example 1 to Example 3 and Comparative Example 1.

### DETAILED DESCRIPTION OF THE EMBODIMENTS

Advantages and features of the present disclosure and methods of accomplishing the same may be understood more readily by reference to the following detailed description of preferred embodiments and the accompanying drawings. However, the present disclosure is not limited to the exemplary embodiments described hereinafter, and may be embodied in many different forms. The following exemplary embodiments are provided to make the disclosure of the present disclosure complete and to allow those skilled in the art to clearly understand the scope of the present disclosure, and the present disclosure is defined only by the scope of the appended claims. Throughout the specification, the same reference numerals denote the same constituent elements.

When referring to a part as being “on” or “above” another part, it may be positioned directly on or above another part, or another part may be interposed therebetween. In contrast, when referring to a part being “directly above” another part, no other part is interposed therebetween.

In some exemplary embodiments, detailed description of well-known technologies will be omitted to prevent the disclosure of the present disclosure from being ambiguous. Unless otherwise defined, all terms (including technical and scientific terms) used herein have the same meaning as commonly understood by one of ordinary skill in the art. In the present specification, unless explicitly described to the contrary, the word “comprise” and variations such as “comprises” or “comprising” will be understood to imply the inclusion of stated elements but not the exclusion of any other elements. Further, as used herein, the singular forms “a”, “an”, and “the” are intended to include the plural forms as well, unless the context clearly indicates otherwise.

A catalyst for removing a nitrogen oxide according to an embodiment includes a gamma alumina powder support in which at least one selected from the group consisting of titanium (Ti), lanthanum (La), and zirconium (Zr) is supported, and iridium (Ir) and ruthenium (Ru) may be further supported on the support.

Currently, a three-way catalyst (TWC) is mainly used for simultaneous reduction of carbon monoxide, hydrocarbons, and a nitrogen oxide. However, in the case of the three-way catalyst, nitrogen oxide purification performance is rapidly lowered in a region in which an air/fuel ratio (λ) exceeds 1.00. In addition, in a region in which the catalyst deteriorates due to exposure to high temperature exhaust gas and the air/fuel ratio (λ) exceeds 1.05, the nitrogen oxide purification performance is only about 10%, thus it is difficult to apply it to an actual vehicle.

However, in a case of using a catalyst in which iridium (Ir) and ruthenium (Ru) are supported on the alumina support in which at least one selected from the group consisting of titanium (Ti), lanthanum (La), and zirconium (Zr) is support as in the present embodiments, even though the air/fuel ratio (λ) exceeds 1.00, it is possible to significantly improve the nitrogen oxide purification performance. In addition, since the catalyst according to the present embodiments has high heat resistance, catalyst deterioration due to exposure to high temperature exhaust gas is prevented, and thus the nitrogen oxide purification performance is excellent even though the air/fuel ratio (λ) exceeds 1.05.

In the present embodiment, at least one selected from the group consisting of titanium (Ti), lanthanum (La), and zirconium (Zr) may be supported in a range of 0.1 wt % to 35 wt % with respect to 100 wt % of the alumina support, and more specifically, in a range of 1 wt % to 30 wt % or 2 wt % to 28 wt %.

The titanium (Ti) may be supported in a range of 1 wt % to 15 wt %, and more specifically 5 wt % to 13 wt % or 7 wt % to 12 wt %, with respect to 100 wt % of the support. When a supported amount of titanium (Ti) is 1 wt % or less with respect to 100 wt % of the support, a content of titanium (Ti) is excessively low, so that an effect of improving performance may be insignificant. In addition, in the case of exceeding 15 wt %, excessively supported titanium may interfere with the interaction between iridium (Ir), ruthenium (Ru), and alumina, thereby reducing catalytic performance.

The lanthanum (La) may be supported in a range of 0.5 wt % to 10 wt %, more specifically, 1 wt % to 8 wt % or 1 wt % to 5 wt %, with respect to 100 wt % of the support. When a supported amount of lanthanum is 0.5 wt % or less with respect to 100 wt % of the support, a content of lanthanum is excessively low, so that an effect of improving performance may be insignificant. In addition, in the case of exceeding 10 wt %, excessively supported lanthanum (La) may interfere with the interaction between iridium (Ir), ruthenium (Ru), and alumina, thereby reducing catalytic performance.

The zirconium (Zr) may be supported in a range of 15 wt % to 35 wt %, and more specifically 18 wt % to 30 wt % or 20 wt % to 28 wt %, with respect to 100 wt % of the support. When a supported amount of zirconium is 15 wt % or less with respect to 100 wt % of the support, a content of zirconium is low, so that an effect of improving performance may be insignificant. In addition, in the case of exceeding 35 wt %, excessively supported zirconium (Zr) may interfere with the interaction between iridium (Ir), ruthenium (Ru), and alumina, thereby reducing catalytic performance.

The iridium (Ir) may be supported in a range of 0.1 wt % to 5 wt %, and more specifically 0.5 wt % to 4 wt % or 1 wt % to 3 wt %, with respect to 100 wt % of the support. When a supported amount of iridium is 0.1 wt % or less with respect to 100 wt % of the support, an active reaction point thereof is small, and thus, nitrogen oxide reduction performance is lowered. In addition, in the case of exceeding 5 wt %, the iridium (Ir) may be aggregated in an excessive amount, and it is not preferable from an economic point of view due to a high price of iridium.

The ruthenium (Ru) may be supported in a range of 0.1 wt % to 3 wt %, and more specifically 0.5 wt % to 2 wt % or 0.8 wt % to 1.5 wt %, with respect to 100 wt % of the support. When a supported amount of ruthenium is 0.1 wt % or less with respect to 100 wt % of the support, an active reaction point thereof is small, and thus, the nitrogen oxide reduction performance is lowered. In addition, in the case of exceeding 5 wt %, the ruthenium (Ru) may be aggregated in an excessive amount, and it is not preferable from an economic point of view due to a high price of ruthenium.

A method for manufacturing a catalyst for removing a nitrogen oxide according to another embodiment may include: manufacturing a first support by supporting at least one selected from a group consisting of titanium (Ti), lanthanum (La), and zirconium (Zr) on an alumina support; manufacturing a second support by supporting iridium (Ir) and ruthenium (Ru) on the first support; and calcining the second support at a high temperature in an air condition and slurry-coating a honeycomb structure support.

First, at least one selected from the group consisting of titanium (Ti), lanthanum (La), and zirconium (Zr) is supported on a powder-type gamma alumina support to manufacture the first support.

Specifically, at least one precursor selected from the group consisting of titanium oxide (TiO₂), lanthanum oxide (La₂O₃), and zirconium oxide (ZrO₂) is dissolved in water or an organic solvent and then supported on the alumina support. Next, the first support may be manufactured by calcining it for 5 to 12 hours in a range of 400 to 600 degrees Celsius.

A detailed description and a content of the titanium (Ti), the lanthanum (La), the zirconium (Zr), and the like are the same as described in the above embodiment, which will be omitted herein.

Next, iridium (Ir) and ruthenium (Ru) are supported on the first support to manufacture the second support.

Specifically, iridium chloride (IrCl₃) and ruthenium chloride (RuCl₃) are dissolved in water and then supported on the first support. Next, the second support may be manufactured by drying it for 12 to 24 hours in a range of 80 to 120 degrees.

In this case, a detailed description and a content of the iridium, the ruthenium (Ru), and the like are the same as described in the above embodiment, which will be omitted herein.

Next, a heat treatment process of the second support may be performed for 3 to 12 hours in a range of 400° C. to 600° C.

As such, the catalyst for removing a nitrogen oxide according to the present embodiment manufactured by the method in which at least one selected from the group consisting of titanium (Ti), lanthanum (La), and zirconium (Zr) is supported on the alumina support to manufacture the first support and then iridium (Ir) and ruthenium (Ru) are supported thereon to manufacture the second support, significantly improves the nitrogen purification performance in a region in which an air/fuel ratio (λ) exceeds 1.00.

In addition, in exemplary embodiments, excellent nitrogen oxide purification performance is provided even in a region in which the air/fuel ratio (λ) exceeds 1.05 because an engine deteriorates due to exposure to high temperature exhaust gas.

Hereinafter, examples will be described in detail. However, the following examples are illustrative of the present disclosure, so the present disclosure is not limited thereto.

### EXAMPLE 1

After dissolving 2.64 g of TiCl₄ in water, it was supported on 10 g of γ-aluminum oxide and then calcined at 500° C. for 6 hours to manufacture a first support.

Next, after dissolving 0.42 g of IrCl₃ and 0.31 g of RuCl₃ in water, it was supported on 10 g of the first support and then dried at 100° C. for 12 hours to manufacture a second support.

By drying the second support and then performing heat treatment at a temperature of 500° C. under a high humidity condition for 5 hours, a catalyst (IrRu/Ti—Al₂O₃) in which iridium-ruthenium is also supported on a titanium-supported aluminum oxide was manufactured.

In this case, based on the total catalyst, a supported amount of Ti was 5.8 wt %, a supported amount of Ru was 1 wt %, and a supported amount of Ir was 2 wt %.

### EXAMPLE 2

After dissolving 0.31 g of La(NO₃)₃ in water, it was supported on 10 g of γ-aluminum oxide and then calcined at 500° C. for 6 hours to manufacture a first support.

Next, after dissolving 0.42 g of IrCl₃ and 0.31 g of RuCl₃ in water, it was supported on 10 g of the first support and then dried at 100° C. for 12 hours to manufacture a second support.

By drying the second support and then performing heat treatment at a temperature of 500° C. under a high humidity condition for 5 hours, a catalyst (IrRu/La—Al₂O₃) in which iridium-ruthenium is also supported on lanthanum-supported aluminum oxide was manufactured.

In this case, based on the total catalyst, a supported amount of La was 1.2 wt %, a supported amount of Ru was 1 wt %, and a supported amount of Ir was 2 wt %.

### EXAMPLE 3

After dissolving 4.82 g of ZrOCl₂ in water, it was supported on 10 g of γ-aluminum oxide and then calcined at 500° C. for 6 hours to manufacture a first support.

Next, after dissolving 0.42 g of IrCl₃ and 0.31 g of RuCl₃ in water, it was supported on 10 g of the first support and then dried at 100° C. for 12 hours to manufacture a second support.

By drying the second support and then performing heat treatment at a temperature of 500° C. under a high humidity condition for 5 hours, a catalyst (IrRu/Zr—Al₂O₃) in which iridium-ruthenium is also supported on a zirconium-supported aluminum oxide was manufactured.

In this case, based on the total catalyst, a supported amount of Zr was 18 wt %, a supported amount of Ru was 1 wt %, and a supported amount of Ir was 2 wt %.

### COMPARATIVE EXAMPLE 1

After dissolving 0.42 g of IrCl₃ and 0.31 g of RuCl₃ in water, it was supported on 10 g of γ-aluminum oxide and then dried at 100° C. for 12 hours. By drying it and then calcining the sample under humid air at a temperature of 500° C. for 5 hours, a catalyst (IrRu/Al₂O₃) in which iridium-ruthenium is supported on an aluminum oxide was manufactured.

In this case, based on the total catalyst, a supported amount of Ru was 1 wt %, and a supported amount of Ir was 2 wt %.

### EXPERIMENTAL EXAMPLE 1

### Nitrogen Oxide Removal Experiments on New Products

The NOₓ purification performance was tested for catalysts manufactured according to Example 1 to Example 3 and Comparative Example 1 as follows.

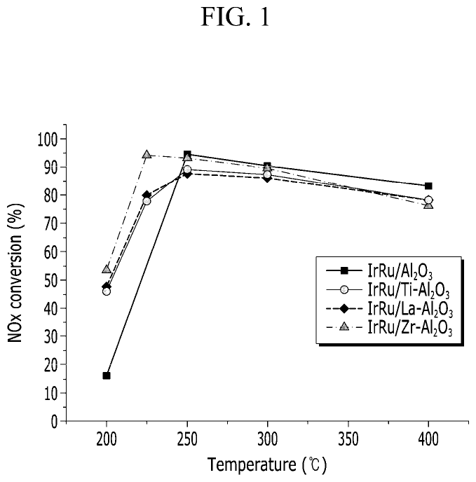

First, 0.1 g of a catalyst prepared as a powder type was filled in a quartz reaction tube, and then a pre-treatment process was performed at 450° C. for 2 hours while flowing H₂ gas at 10%. Next, exhaust gas including 1 vol % of CO, 0.1 vol % of NO, 1 vol % of O₂, 10 vol % of H₂O, and the remainder of N₂ was supplied at a space velocity of 200,000 h⁻¹ (air ratio (λ)=1.09). In this case, a reaction temperature was adjusted to 200° C. to 400° C., and the nitrogen oxide (NOₓ) conversion rate of the exhaust gas passing through the catalyst according to the reaction temperature was measured to be shown in FIG. 1 and Table 1 below.

TABLE 1
Nitrogen oxide purification performance at 200° C.

| Comparative | | | |
|---|---|---|---|
| Example 1 | Example 1 | Example 2 | Example 3 |
| (IrRu/Al₂O₃) | (IrRu/Ti—Al₂O₃) | (IrRu/La—Al₂O₃) | (IrRu/Zr—Al₂O₃) |
| 16% | 46% | 48% | 53% |

Referring to Table 1 and FIG. 1, it can be seen that when being compared with the catalyst according to Comparative Example 1 including an aluminum oxide support on which iridium (Ir) and ruthenium (Ru) are supported, the purification performance thereof is improved by at least 30% or more at a low temperature region of 200° C. in the case of the catalysts of Example 1 to Example 3 in which at least one of titanium (Ti), lanthanum (La), or zirconium (Zr) is further supported on the aluminum oxide support on which iridium (Ir) and ruthenium (Ru) are supported, as in the present disclosure.

### EXPERIMENTAL EXAMPLE 2

### Nitrogen Oxide Removal Experiments on Deteriorated Products

A deterioration process was performed for the catalysts manufactured according to Examples 1 and 2 and Comparative Example 1, and then, the NOₓ purification performance of the catalysts was tested as follows.

The deterioration process was performed for 25 hours while filling a tubular reactor with a catalyst of a powder type and then flowing a gas including 2 vol % of H₂O and the remainder of air at 900° C.

In the purification performance test, first, 0.1 g of the deteriorated catalyst of a powder type was filled in a quartz reaction tube, and then, a pre-treatment process was performed at 450° C. for 2 hours while flowing H₂ gas at 10%. Next, exhaust gas including 1 vol % of CO, 0.1 vol % of NO, 1 vol % of O₂, 10 vol % of H₂O, and the remainder of N₂ was supplied at a space velocity of 200,000 h⁻¹ (air ratio (λ)=1.09). In this case, a reaction temperature was adjusted to between 200° C. and 400° C., inclusive, and the nitrogen oxide (NOₓ) conversion rate of the exhaust gas passing through the catalyst according to the reaction temperature was measured as shown in Table 2 and Table 3 below.

TABLE 2
Nitrogen oxide purification performance at 225° C.

| Comparative | | | |
|---|---|---|---|
| Example 1 | Example 1 | Example 2 | Example 3 |
| (IrRu/Al₂O₃) | (IrRu/Ti—Al₂O₃) | (IrRu/La—Al₂O₃) | (IrRu/Zr—Al₂O₃) |
| 25% | 44% | 50% | 87% |

TABLE 3
Nitrogen oxide purification performance at 400° C.

| Comparative | | |
|---|---|---|
| Example 1 | Example 1 | Example 2 |
| (IrRu/Al₂O₃) | (IrRu/Ti—Al₂O₃) | (IrRu/La—Al₂O₃) |
| 64% | 81% | 81% |

Referring to Table 2 and Table 3, it can be seen that when being compared with the catalyst according to Comparative Example 1 including an aluminum oxide support on which iridium (Ir) and ruthenium (Ru) are supported, the purification performance thereof is improved by up to 62% at a low temperature region of 225° C. in the case of the catalysts of Example 1 to Example 3 in which at least one of titanium (Ti), lanthanum (La), and zirconium (Zr) is further supported on the aluminum oxide support on which iridium (Ir) and ruthenium (Ru) are supported as in the present disclosure. In addition, it can be seen that the titanium (Ti) and lanthanum (La) addition catalysts have improvement of 17% in the nitrogen oxide purification performance even at a high temperature region of 400° C.

Thus, as in the embodiments, in the case of the catalyst manufactured by supporting iridium (Ir) and ruthenium (Ru) on the alumina support on which at least one selected from a group of titanium (Ti), lanthanum (La), and zirconium (Zr) is supported, the nitrogen oxide purification performance at a low temperature region may be significantly improved. In addition, the catalysts according to the present embodiments may significantly improve the nitrogen oxide purification performance in the low temperature and high temperature regions even after exposure to high temperature exhaust gas.

While the exemplary embodiments of the present disclosure have been described hereinbefore, it will be understood by those skilled in the art that various changes in form and details may be made thereto without departing from the technical spirit and essential features of the present disclosure.

Therefore, it is to be understood that the above-described exemplary embodiments are for illustrative purposes only, and the scope of the present disclosure is not limited thereto. The scope of the present disclosure is determined not by the above description, but by the following claims, and all changes or modifications from the spirit, scope, and equivalents of the claims should be construed as being included in the scope of the present disclosure.

What is claimed is:

1. A catalyst for removing a nitrogen oxide, comprising:
a powdery gamma alumina support on which at least one selected from a group consisting of titanium (Ti), lanthanum (La), and zirconium (Zr) is supported,
wherein the support is further supported with iridium (Ir) and ruthenium (Ru).

2. The catalyst for removing the nitrogen oxide of claim 1, wherein
the at least one selected from the group consisting of titanium (Ti), lanthanum (La), and zirconium (Zr) is supported in a range of 0.1 wt % to 35 wt % with respect to 100 wt % of the alumina support.

3. The catalyst for removing the nitrogen oxide of claim 2, wherein
the titanium (Ti) is supported in a range of 1 wt % to 15 wt % with respect to 100 wt % of the alumina support.

4. The catalyst for removing the nitrogen oxide of claim 2, wherein
the lanthanum (La) is supported in a range of 0.5 wt % to 10 wt % with respect to 100 wt % of the alumina support.

5. The catalyst for removing the nitrogen oxide of claim 2, wherein
the zirconium (Zr) is supported in a range of 15 wt % to 35 wt % with respect to 100 wt % of the alumina support.

6. The catalyst for removing the nitrogen oxide of claim 1, wherein
the iridium (Ir) is supported in a range of 0.1 wt % to 5 wt % with respect to 100 wt % of the alumina support.

7. The catalyst for removing the nitrogen oxide of claim 1, wherein
the ruthenium (Ru) is supported in a range of 0.1 wt % to 3 wt % with respect to 100 wt % of the alumina support.

8. The catalyst for removing the nitrogen oxide of claim 1, wherein
the support is a powder of a gamma structural aluminum oxide (Al₂O₃).

9. A method of manufacturing a catalyst for removing a nitrogen oxide, comprising:
preparing a first support by supporting at least one selected from a group of titanium (Ti), lanthanum (La), and zirconium (Zr) on a powdery gamma alumina support;
preparing a second support by supporting iridium (Ir) and ruthenium (Ru) on the first support; and
calcining the second support in an air atmosphere.

10. The manufacturing method of the catalyst for removing the nitrogen oxide of claim 9, wherein
the calcining of the second support is performed for 3 to 12 hours at a temperature in a range of 400° C. to 600° C.
